(19) United States
(12) Patent Application Publication
(10) Pub. No.: US 2004/0140880 A1
(43) Pub. Date: Jul. 22, 2004

(54) Coupling device

(75) Inventors: Espen Haugs, Sperrebotn (NO); Frank Strand, Moss (NO); Jan Otto Ringdal, Oslo (NO)

Correspondence Address: TESTA, HURWITZ & THIBEAULT, LLP, HIGH STREET TOWER, 125 HIGH STREET, BOSTON, MA, 02110, US

(73) Assignee: Magtech AS, Moss (NO)

(21) Appl. No.: 10/700,349

(22) Filed: Nov. 3, 2003

Related U.S. Application Data
(60) Provisional application No. 60/422,863, filed on Nov. 1, 2002.

(30) Foreign Application Priority Data
Nov. 1, 2002 (NO) 2002 5268

(51) Int. Cl. H01F 27/28

(52) U.S. Cl. 336/229

(57) ABSTRACT

The invention relates to an end piece for magnetic coupling of core parts to a closed path for magnetic flux, characterized in that it comprises at least an abutment surface for abutment against the core parts and a magnetic path part, where the path part is composed of several approximately parallel, wire-shaped bodies and the abutment surface is composed of the end surfaces of the wire-shaped bodies. The invention also relates to a method for manufacturing the end piece.

### CROSS-REFERENCE TO RELATED APPLICATIONS

This application claims the benefit under 35 U.S.C. § 119 (e) of U.S. Provisional Application No. 60/422,683, filed Nov. 1, 2002, and claims priority to Norwegian Patent Application No. 2002 5268 also filed on Nov. 1, 2002. The entire contents of these two applications are incorporated herein by reference.

### FIELD OF THE INVENTION

The present invention relates to magnetic devices. More particularly, the invention relates to a device that provides a magnetic coupling.

### BACKGROUND OF THE INVENTION

Magnetic core production is usually based on foil, i.e., a magnetic material which forms discrete layers, the layers being stacked on top of one another to produce flat blanks, which in turn are cut and/or rolled into the desired shape. When turning sheet metal into square cores, rolls of sheet metal of the desired width are passed through a cutting machine, which cuts the sheet metal into the length required. The resulting stacks of sheet metal are assembled to form the core dimension. The size of the core is based on the capacity required for the transformer or the inductive unit. These sheet metal assemblies are referred to as foliated sheet metal. The limitations of foliated sheet metal arise more from the shape of the core than its size. A foliated core is limited to a square or rectangular shape. A magnetic core for a three-phase system provides one example. These cores consist of three legs which are interconnected by two yokes, one at the top and one at the bottom. On the other hand, when manufacturing a ring core, the raw material is rolled into ring cores of the desired dimension. Examples of this approach include a ring core transformer and a U-core transformer.

Another method of manufacturing magnetic cores is based on powder material, which is placed in a mold and heated under pressure (sintering). This type of core is specially adapted for converters where the AC voltage is of high frequency (for example, 10-100 kHz).

When the magnetic core is made of foil material, achieving a low loss connection between an inner core tube and an outer core tube becomes difficult. In one approach, connectors are used to connect a magnetic core consisting of two tubes arranged in parallel beside each other where one or more windings are wound around the tubes. However, if one attempts to bend a body consisting of rolled foils, the material becomes stressed and its magnetic properties are reduced.

Although it is possible to make end pieces by means of sintering, sintered materials of iron powder and ferrites can only tolerate 20 to 30% of the flux density of cores of magnetic sheet metal. Sintered material, therefore, is of limited use as a field connector between cores that have greater flux density than the connectors made of sintered or ferrite-based materials can tolerate.

### SUMMARY OF THE INVENTION

The present invention addresses the shortcomings of the prior art by implementing coupling devices having low losses. The function of the device is to provide a flux distributor or an end piece for magnetic cores. The device provides greater design flexibility for the core together with less hysteresis loss compared with the known solutions.

To achieve a low level of loss when using magnetic cores, a closed path should be provided for the magnetic flux generated when a winding is wound around the core and current is applied.

For example, for a magnetic core comprising an inner tube part and an outer tube part which are arranged concentrically in relation to each other, where a winding is placed in the gap between the inner and the outer tube part, connectors must be employed at the ends of the tubes to provide a closed path for the flux.

As already mentioned, the function of connectors (for example, end pieces) is to provide a closed path for the magnetic flux. The end pieces should establish a path which “follows” the flux lines of the magnetic flux in the core in order to reduce losses to an acceptable level. In the prior art, the flux lines are forced to follow specific magnetic paths. In an embodiment of the invention, however, the magnetic paths are placed in the natural path of the flux lines.

In one aspect, the invention provides end connectors, which can be adapted to different kinds of core parts, which are simple and inexpensive to produce, and which result in a low level of loss.

In one embodiment, an end piece for magnetic coupling of core parts provides a closed path for magnetic flux. The end piece includes at least an abutment surface for abutment against the core parts and a magnetic path part, where the path part includes several parallel wire-shaped bodies and the abutment surface includes the end surfaces of the wire-shaped bodies.

In a further embodiment of the invention, the wire-shaped bodies are made of a magnetizable material. In a version of this embodiment, the material is iron alloyed with silicon. In another version, the material is pure iron. In still another version, the wire-shaped bodies are manufactured from metallic glass materials. In one embodiment, the wire bodies are electrically insulated by a thin film of insulating material applied to the surface of the wire. The actual shape of the wire may be circular, oval, square, or rectangular. Alternatively, the wire may be rolled into thin strips.

In an embodiment of the invention, each wire body of magnetizable material forms a path for the magnetic flux, thereby enabling the geometry of the end pieces to be easily adapted to the geometry of the core parts and the natural path of the flux. In a version of the embodiment the path part is hollow, i.e., the wire-shaped bodies form the surface of the end piece, and the abutment surfaces are substantially annular. In yet a further version, the end piece includes an inner annular surface that has the same area as an outer annular surface.

In another embodiment, a composite core for a magnetic device includes at least one core part and at least one end piece for magnetic coupling of the at least one core part to a closed path for a magnetic flux. The end piece includes wire-shaped magnetic bodies which include end surfaces. The end piece also includes at least an abutment surface for abutment of the core part and a magnetic path part. The magnetic path part includes a plurality of substantially adjacent wire-shaped bodies. Also, the abutment surface includes the end surfaces of the wire-shaped bodies. In a version of this embodiment, the core part is made of sheet magnetic material.

In order to better illustrate one embodiment of the invention, two tubular core parts are arranged one inside the other. An end piece for geometry of this kind is in the form of a half toroid which is intersected by a plane comprising the toroid's largest diameter. The end piece includes a path part with wire bodies which form arcs between an inner annular abutment surface and an outer annular abutment surface.

The toroid's largest diameter will therefore substantially correspond to the outer diameter of the outer core part and the smaller diameter will correspond to the inner diameter of the inner core part. The abutment surfaces will be an outer annular surface for abutment against the outer core part and an inner annular surface for abutment against the inner core part.

In such an embodiment, the end piece is preferably formed by winding the magnetic wire around an annular body with a round cross-section (i.e., a torus). Two symmetrical end pieces with a flat surface are thereby provided, consisting of small areas of magnetic material arranged beside one another. The area is formed by the wires' cross-section and will have a shape that depends on the shape of the wire.

A characteristic of the end piece according to this embodiment is that the area with magnetic material in both the abutment surfaces is guaranteed to be the same because the abutment surfaces are composed of the end surfaces of the wire-shaped parts. This is important because it affects the flux density in the material and the material's condition with regard to saturation. This can be easily seen in connection with a toroidal mold, since the toroid's inner circumference is smaller than the outer circumference, thereby giving a “thicker” layer of wire bodies on the inside of the toroid than on the outside.

In another embodiment, the end piece is adapted for use together with core parts, which are tubular in shape, but which are mounted beside one another. In this embodiment, a toroid is also used as the mold, however, the wires are wound along the circumference of the toroid. The toroid is divided in a plane substantially perpendicular to a linear axis located at the center of the toroid. The resulting end piece includes two annular surfaces arranged beside each other, while the wire bodies form arcs around the surfaces.

The core parts can also be tubular with a square cross-section. In this case, the mold is square in circumference with a round or square cross-section. In another embodiment, the mold has a cross-section with a shape selected from the group consisting of circular, oval, triangular, square, rectangular, parallelogrammatic and polygonal shaped cross-sections.

In another aspect, the invention relates to a method for producing an end piece with an abutment surface for abutment against core parts and a magnetic path part.

The method includes the step of providing an end piece for connection of the core parts based on the geometry of the core parts, winding a wire of magnetic material around the mold in order to create the magnetic paths, dividing the wire winding and the mold in two in order to form the abutment surfaces, and removing the mold and treating the abutment surfaces in order to give them a smooth surface.

The term “wire” and “wire body” is used in the present description in order to identify a body where the length is several times greater than the width of the cross-section (diameter in the case of a round cross-section). Both the wire and the wire body may consist of a single wire or of a loosely wound conductor with many individual wires.

In one embodiment, the wire bodies are kept together by means of impregnation with a dimensionally stable material or by means of a holding mold. In a version of this embodiment, the impregnation occurs before the wire winding and mold are divided.

In yet another embodiment, the invention provides a method of manufacturing an end piece for magnetic coupling of core parts to form a closed magnetic path for a magnetic flux. The end piece includes a magnetic path part with at least an abutment surface for abutment of the magnetic path part against the core parts. The path part includes a plurality of substantially adjacent wire-shaped bodies. Each wire-shaped body includes an end surface. Further, the abutment surface includes end surfaces of the wire-shaped bodies. The method includes the steps of winding a wire of magnetic material around a mold in order to form the magnetic path part. The wire winding and the mold are divided to form abutment surfaces. The mold is removed from the wire winding, and the abutment surfaces are treated to provide a smooth surface. In this embodiment, the shape of the abutment surfaces of the end pieces correspond to a shape of an abutment surface of the core parts.

In a further embodiment, the core parts include a first tube and a second tube that are concentrically arranged. The mold is a toroid. The method includes the steps of winding the wire around the toroid in an annular direction, relative to a linear axis located at a center of the toroid. The mold and the wire winding are divided in a plane comprising the largest diameter of the toroid to form a first abutment surface and a second abutment surface. Further, the first abutment surface forms an outer ring for abutment against the first tube and the second abutment surface forms an inner ring for abutment against the second tube.

In still a further embodiment, the core parts of two tubes are placed in parallel beside each other. The two tubes are at a distance from each other and the mold is a toroid. The method includes the steps of winding the wire around the toroid in an annular direction relative to a linear axis located at a center of the toroid. The mold and wire winding are divided in a plane perpendicular to the annular direction to form abutment surfaces. The abutment surfaces include two rings for abutment against the core parts.

In yet another embodiment, the mold comprises an inner toroid and an outer toroid. The method includes the steps of centering the inner toroid within a tube formed by the outer toroid. An opening is placed along an outer diameter of the outer toroid, a wire is inserted into the tube through the opening, and the wire is wound within the outer toroid. Further, the mold comprises a gap where the wire winding can be intersected in a plane perpendicular to the annular direction, and the abutment surfaces comprise two rings for abutment against the core parts. In a version of this embodiment, the inner toroid is a torus and the outer toroid is a torus.

In still a further embodiment, the core parts are a number of tubes located beside one another in a circle. The tubes are located at a distance from one another and the mold includes a hollow outer toroid. The method includes the steps of dividing the outer toroid along a path comprising a fixed radius from a linear axis located at a center of the toroid, locating an inner toroid inside the outer toroid, winding the wire within the outer toroid in an annular direction relative to the linear axis, and dividing the mold in the wire winding in a plane perpendicular to the annular direction. The path includes a cylindrical plane perpendicular to a radial direction where the torus has a largest diameter, and the abutment surfaces comprise two half-rings for abutment against the core parts. In yet another embodiment, a composite core for a magnetic device is manufactured. The method of manufacturing includes the steps of manufacturing at least one core part by rolling the cutting sheet material, manufacturing at least one end piece, and joining at least one core part to at least one end piece by taping or gluing the end piece to the core parts. Further, the composite core is impregnated with transformer varnish and heated until the varnish is cured. In a version of this embodiment, the end piece is taped to the core parts. The tape can be selected from a group consisting of seize tape, glass fiber tape, or cotton tape. In addition, the tape used to secure the end piece to the core part may be any type of tape capable of securing transformer windings.

In a version of any of the preceding embodiments, the toroid is a torus. In a further version of any of the preceding embodiments, the mold for winding the wire is a straight body or an annular body with a cross-section having a shape selected from a group consisting of circular, oval, triangular, square, rectangular, parallelogrammatic, and polygonal shaped cross-sections.

The invention will now be explained in greater detail with reference to the drawings:

### BRIEF DESCRIPTION OF THE DRAWINGS

FIG. 1a illustrates a mold according to a first embodiment of the invention;

FIG. 1b illustrates a step in the manufacture of an embodiment of the invention;

FIGS. 1c-1f illustrate molds according to further embodiments of the invention;

FIG. 2 illustrates another step in the manufacturing process;

FIG. 3 illustrates an end piece according to an embodiment of the invention;

FIG. 4 illustrates the areas of the abutment surfaces in the end piece of FIG. 3;

FIG. 5 illustrates the end piece in FIG. 3 together with core parts;

FIG. 6a illustrates a step in the manufacture of a second embodiment of the invention;

FIG. 6b illustrates a version of the second embodiment of the invention;

FIG. 7 illustrates an end piece manufactured according to the embodiment of FIG. 6;

FIG. 8 illustrates the end piece of FIG. 7 together with core parts;

FIG. 9 illustrates a mold for manufacture of a third embodiment of the invention;

FIG. 10 illustrates the wire bodies in the mold of FIG. 9; and

FIG. 11 illustrates the end piece in FIG. 10 with core parts.

### DETAILED DESCRIPTION

To manufacture the end piece according to the invention, the geometry of the core parts is used as basis and a mold adapted to the core parts is provided.

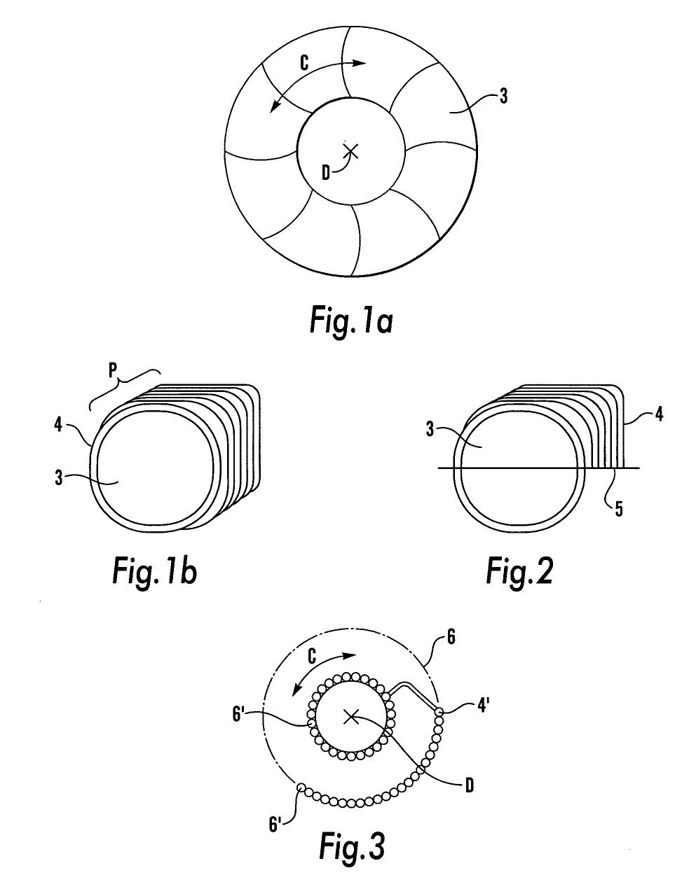

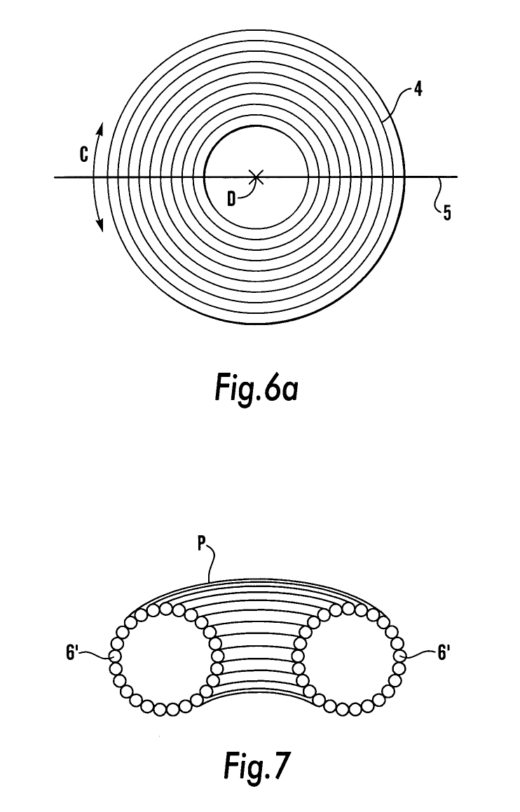

If the core parts are in the form of two concentric tubes 1, 2 (FIG. 5), a mold 3 can be provided in the form of a toroid (FIG. 1a) with a linear axis D located at the center of the toroid 3. A magnetic wire is wound around the mold 3 in order to form wire bodies 4 (FIG. 1b) that provide a magnetic path part (P). The wire bodies 4 will be kept substantially adjacent either by means of impregnation, a special adhesive, a mold or some combination of these approaches. Thereafter, (FIG. 2) the mold 3 and the wire winding with the wire bodies 4 will be intersected along a plane 5 comprising the mold's 3 largest diameter. In another embodiment, the mold 3 has a cross-section with a shape selected from the group consisting of circular, oval, triangular, square, rectangular, parallelogrammatic, and polygonal shaped cross-sections. Versions of this embodiment of the mold 3 are shown in FIGS. 1c-1f.

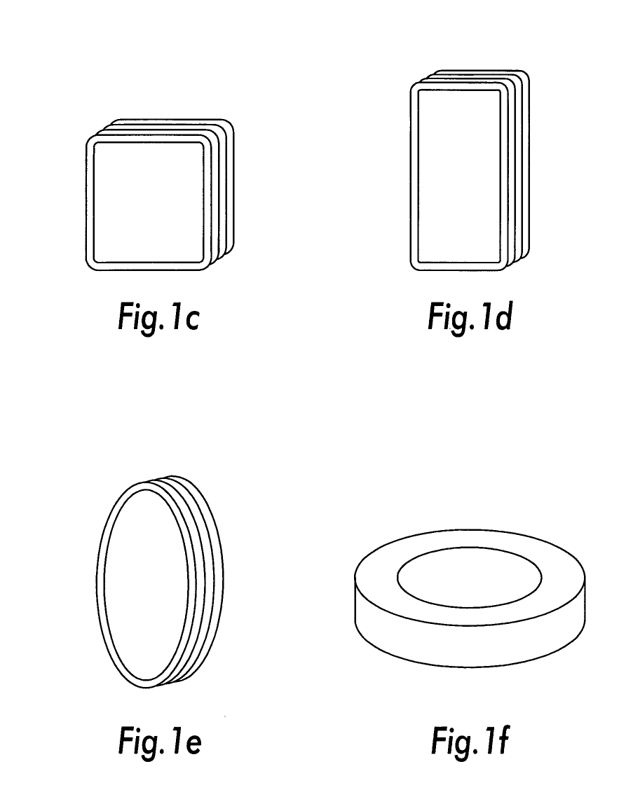

FIG. 3 illustrates the end piece 6 with the end surfaces 4′ of the wire bodies 4 which form the end piece's 6 abutment surface 6′. An annular direction C can be identified relative to the linear axis D.

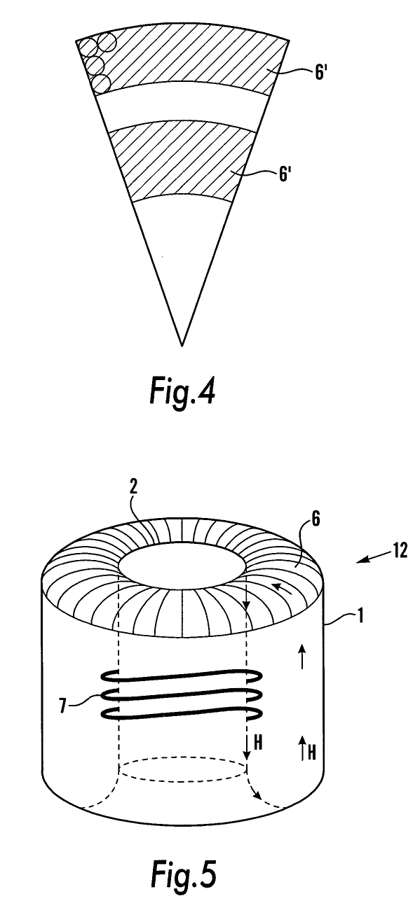

FIG. 4 illustrates that the area of the inner abutment surface 6′ is the same as the area of the outer abutment surface 6′. In FIG. 4, the outer abutment surface 6′ is longer in the annular direction than the inner abutment surface 6′. The equal size abutment areas are achieved by increasing the width of the inner abutment surfaces 6′, i.e., making the inner abutment surface 6′ thicker.

FIG. 5 illustrates two end pieces 6 which together with the core parts 1 and 2 form a composite core 12 with closed magnetic paths. If a winding 7 is provided in the gap between the core parts 1 and 2 and the winding is supplied with current, a magnetic field H will be created in the material. The field H is marked by arrows which show that the path for the field H is closed.

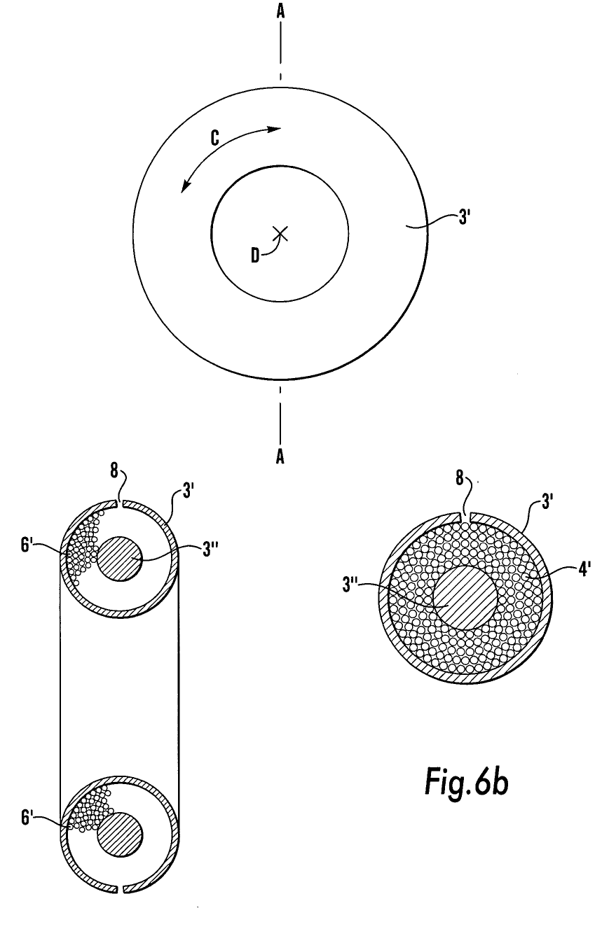

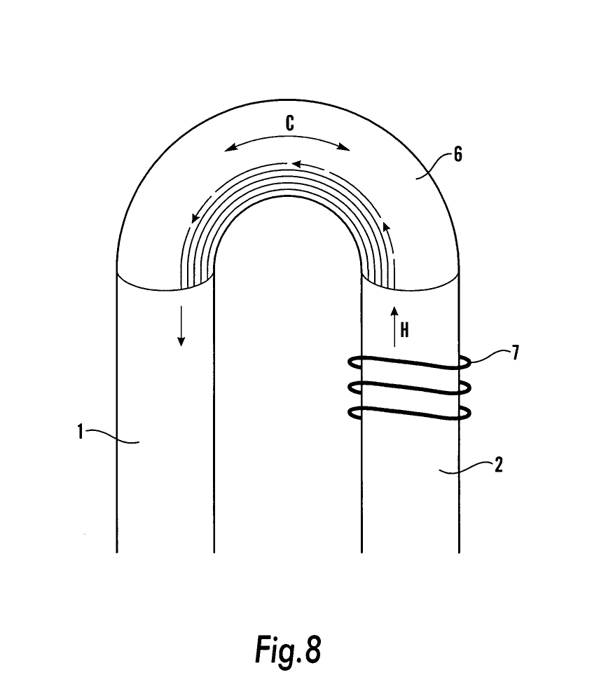

If the core parts are in the form of two tubes 1 and 2 to be placed beside each other (FIG. 8), the mold 3 can also have the shape of a toroid (FIG. 1a). However, the magnetic wire will be wound around the toroid in an annular direction C relative to a linear axis D located at the center of the toroid (FIG. 6a). In this embodiment, the mold and the wire winding, with the wire bodies 4, will be intersected in a plane 5 perpendicular to the mold's 3 annular direction C, where the plane 5 includes the linear axis D. As a result, the abutment surfaces 6′ form two rings for abutment against the core parts 1 and 2. In one embodiment, the toroid is a torus.

A variant of the mold 3 for providing an end piece for the core parts in FIG. 8 is illustrated in FIG. 6b. The mold in FIG. 6b includes an inner toroid 3″ which is centered in a hollowed-out toroid 3′ with a small opening 8 along the outer diameter. The wire 4 can be inserted within the toroid 3′ from the outside, the wire 8 is wound inside the hollow toroid 3′ in an annular direction C relative to a linear axis D located at the center of the toroid 3′. As a result, the wire is located in the cavity between the inner and the outer toroid (3″ and 3′ respectively). Further, as shown in the lower left of FIG. 6b, the mold can include a gap (not shown) where the wire winding 4 can be intersected in a plane perpendicular to the annular direction C, with the result that the abutment surfaces 6′ form two rings for abutment against the core parts 1 and 2.

FIG. 8 illustrates part of a composite core 12 comprising a first end piece 6 and a second end piece 6 (not shown in this view) which together with the core parts 1 and 2 form the composite core 12 with closed paths. If a winding 7 is provided around one or both the core parts 1 and 2 and the winding is supplied with current, a magnetic field H will be created in the material. The field H is marked with arrows and it can be seen that the path for the field H is closed.

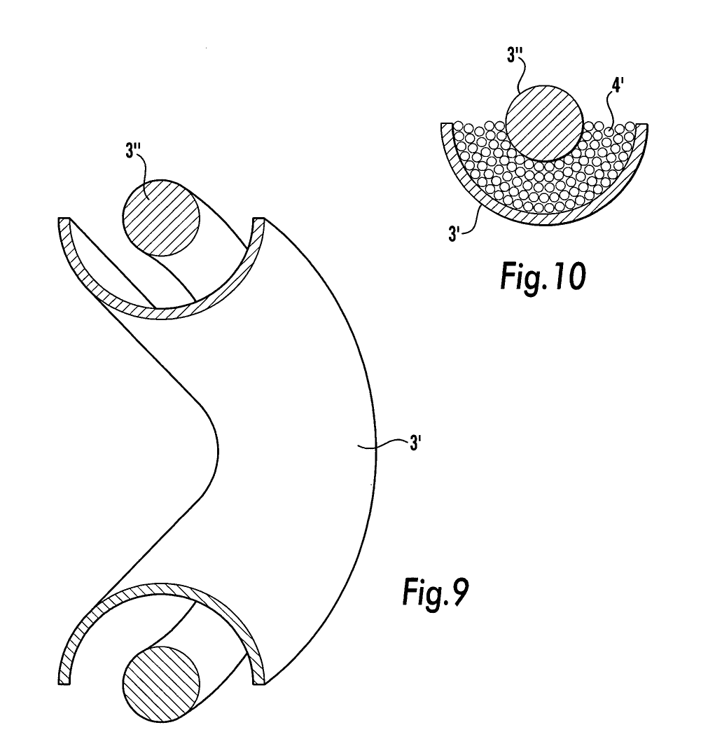

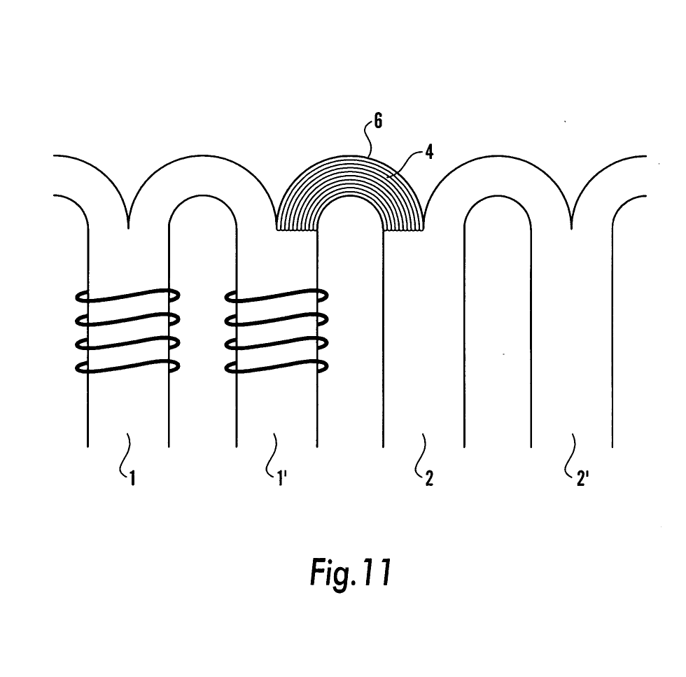

If the core parts 1 and 2 are tubular in form and arranged to be placed beside each other (FIG. 11, core parts 1, 1′, 2, 2′) in a ring (FIG. 11 shows a part of the ring), the mold 3 will consist of an outer toroid 3′ and an inner toroid 3″, which are divided longitudinally perpendicularly to the radial direction where the toroid has the largest diameter (FIGS. 9 and 10). The inner toroid 3″ is then located inside the outer toroid 3′. The wire is wound inside the outer toroid 3′ in the annular direction C relative to the linear axis D located at the center of the toroid 3′. The molded bodies 3′ and 3″ are intersected in a plane perpendicular to the circumferential direction, with the result that the abutment surfaces 6′ form two half rings for abutment against the core parts 1, 1″, etc.

In another embodiment, end pieces 6 for this core are manufactured using the mold, as shown in FIG. 6b. In this case, the mold and the wire winding will be intersected along a plane comprising the toroid's circumference and a plane perpendicular thereto.

An assembled composite core 12 is illustrated in FIG. 11. In one embodiment, the end pieces 6 are fastened to the core parts 1, 2 with tape. In a version of this embodiment, the tape is selected from a group consisting of seize tape, fiber tape, and cotton tape. In another embodiment, the end pieces 6 are glued to the core parts 1, 2. In each of the preceding embodiments, the composite core 12 can be impregnated with transformer varnish and baked until the varnish is cured.

Where the core parts have a square cross-section or another configuration, the mold will have a corresponding square or other configuration. The parameters that can be varied in order to adapt the end piece to different core parts are: a) the shape of the mold, b) placement of the wire bodies on the mold, c) the position of the plane of intersection relative to the wire bodies. With regard to c), although the plane of intersection has been described as perpendicular to the wire body's longitudinal direction, the plane of intersection can be at any angle relative to the wire bodies provided that an abutment surface that corresponds to the core parts is created. For example, the cross-section of the magnetic material for each wire body may be increased by changing the angle. The abutment surfaces of the core parts will then be intersected correspondingly.

Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

What is claimed is:

1. An end piece for magnetic coupling of core parts to a closed path for magnetic flux, the end piece comprising:
a magnetic path part comprising a plurality of substantially adjacent, wire-shaped bodies, each wire shaped body comprising end surfaces; and
at least an abutment surface for abutment of the magnetic path part against the core parts,
wherein the abutment surface comprises the end surfaces of the wire-shaped bodies.

2. The end piece according to claim 1, wherein the wire-shaped bodies are made of a magnetizable material.

3. The end piece according to claim 2, wherein the magnetizable material is iron.

4. The end piece according to claim 1, wherein the magnetic path part is hollow.

5. The end piece according to claim 4, wherein the wire bodies form arcs between an inner annular abutment surface and an outer annular abutment surface.

6. The end piece according to claim 4, wherein the wire bodies form arcs between two annular surfaces arranged beside each other.

7. The end piece according to claim 5, wherein the inner annular surface has the same area as the outer annular surface.

8. The end piece according to claim 6, wherein the annular surfaces are cylindrical and have a uniform thickness.

9. A composite core for a magnetic device, the composite core comprising:
at least one core part; and
at least one end piece for magnetic coupling of the at least one core part to a closed path for magnetic flux, the end piece comprising wire shaped magnetic bodies, the wire shaped magnetic bodies comprising end surfaces,
wherein the end piece comprises at least an abutment surface for abutment against the core part and a magnetic path part,
wherein the magnetic path part comprises a plurality of substantially adjacent, wire-shaped bodies, and
wherein the abutment surface comprises the end surfaces of the wire-shaped bodies.

10. The composite core according to claim 9, wherein the core part comprises sheet magnetic material.

11. The composite core according to claim 9, wherein the core part comprises sintered material.

12. The composite core according to claim 9, further comprising two adjacent cylindrical core parts and two end pieces.

13. The composite core according to claim 9, further comprising two concentric cylindrical core parts.

14. The composite core according to claim 9, further comprising two adjacent parts each having a rectangular cross-section.

15. A method of manufacturing an end piece for magnetic coupling of core parts to a closed magnetic path for magnetic flux, the end piece comprising, a magnetic path part comprising a plurality of substantially adjacent wire-shaped bodies, and at least an abutment surface for abutment of the magnetic path part against the core parts, wherein each wire-shaped body comprises an end surface, and wherein the abutment surface comprises end surfaces of the wire-shaped bodies, the method comprising the steps of:
winding a wire of magnetic material around a mold in order to form the magnetic path part;
dividing the wire winding in two in order to form abutment surfaces;
removing the mold from the wire winding; and
treating the abutment surfaces in order to provide a smooth surface,
wherein abutment surfaces of the end piece have a shape which corresponds to a shape of an abutment surface of the core parts.

16. The method according to claim 15, wherein the core parts comprise a first tube and a second tube, wherein the tubes are concentrically arranged and wherein the mold is a toroid, the method further comprising the steps of:
winding the wire around the toroid in an annular direction relative to a linear axis located at a center of the toroid, and
dividing the wire winding in a plane comprising the largest diameter of the toroid to form a first abutment surface and a second abutment surface,
wherein the first abutment surface forms an outer ring for abutment against the first tube, and
wherein the second abutment surface forms an inner ring for abutment against the second tube.

17. The method according to claim 15, wherein the core parts are two tubes placed in parallel beside each other, wherein the two tubes are at a distance from each other, and wherein the mold is a toroid, further comprising the steps of:
winding the wire around the toroid in an annular direction relative to a linear axis located at a center of the toroid; and
dividing the wire winding in a plane perpendicular to the annular direction to form abutment surfaces,
wherein the abutment surfaces comprise two rings for abutment against the core parts.

18. The method according to claim 17, wherein the mold comprises an inner toroid and an outer toroid, further comprising the steps of:
centering the inner toroid within a tube formed by the outer toroid;
locating an opening along an outer diameter of the outer toroid;
inserting the wire into the tube through the opening; and
winding the wire within the outer toroid,
wherein the mold comprises a gap where the wire winding can be intersected in a plane perpendicular to the annular direction, and
wherein the abutment surfaces comprise two rings for abutment against the core parts.

19. The method according to claim 15, wherein the core parts are a number of tubes located beside one another in a circle, wherein the tubes are located at a distance from one another, and wherein the mold comprises a hollow outer toroid, further comprising the steps of:
dividing the outer toroid along a path comprising a fixed radius from a linear axis located at a center of the toroid;
locating an inner toroid inside the outer toroid;
winding the wire within the outer toroid in an annular direction relative to the linear axis; and
dividing the wire winding in a plane perpendicular to the annular direction;
wherein the path comprises a cylindrical plane perpendicular to a radial direction where 1 the toroid has a largest diameter, and
wherein the abutment surfaces comprise two half rings for abutment against the core parts.

20. The method according to claim 15, wherein the mold has a cross-section with a shape selected from the group consisting of circular, oval, triangular, parallelogrammatic, and polygonal shaped cross-sections.

21. A method of manufacturing a composite core for a magnetic device according to one of claims 15-20, the method comprising the steps of:
manufacturing at least one core part by rolling and cutting sheet material;
manufacturing at least one end piece by the method according to any one of claims 15-20; and
joining the at least one core part to the at least one end piece by taping the core part to the end piece.

22. The method of claim 21, wherein the step of manufacturing at least one core part comprises:
manufacturing the core part by sintering powdered material.

23. The method of claim 21 wherein the core part and the end pieces are taped together with a tape that is selected from a group consisting of seize tape, glass fiber tape, and cotton tape.

24. The method of claim 21, wherein the step of joining the core part to the end piece comprises gluing the core part and the end piece together.
